(19) United States
(12) Patent Application Publication
(10) Pub. No.: US 2016/0004238 A1
(43) Pub. Date: Jan. 7, 2016

(54) Process Control of a Physical Process

(71) Applicant: Dirk Hartmann, Aßling (DE)

(72) Inventor: Dirk Hartmann, Aßling (DE)

(21) Appl. No.: 14/387,969

(22) PCT Filed: Jan. 30, 2013
(86) PCT No.: PCT/EP2013/051760

§ 371 Date: Jun. 8, 2015

(30) Foreign Application Priority Data
Mar. 26, 2012 (DE) 102012204803.0

(51) Int. Cl. G05B 17/02

(52) U.S. Cl. CPC G05B 17/02

(57) ABSTRACT

A process control method includes discretizing a physical process by particle-based domain decomposition into a plurality of partial volumes where one particle replaces a multiplicity of objects interacting within the particular partial volume and defines a first process parameter of the process. The method further includes calculating a second process parameter for the inner particles of the process area by LME approximation and calculating the second process parameter for the outer particles by MLS approximation. The method further includes calculating an interaction variable for the inner particles of the process area by LME approximation and the interaction variables for the outer particles by MLS approximation. The method further includes calculating at least one control variable on the basis of the interaction variables calculated for the inner and outer particles. The method further includes setting a target process parameter for the physical process by the calculated control variable.

### CROSS-REFERENCE TO RELATED APPLICATIONS

The present patent document is a §371 nationalization of PCT Application Serial Number PCT/EP2013/051760, filed Jan. 30, 2013, designating the United States, which is hereby incorporated by reference, and this patent document also claims the benefit of DE 10 2012 204 803.0, filed on Mar. 26, 2012, which is also hereby incorporated by reference.

### TECHNICAL FIELD

The embodiments relate to methods and apparatuses for process control in a physical process running in a process area.

### BACKGROUND

Conventional process engineering control methods or methods for process control, in particular, of complex technical installations, often make no use of any calculation methods to simulate the fundamental physical processes within the installation. One reason for this is the complexity of the fundamental physical process running in the complex installation. A further reason is the calculation resources required to implement the simulation, in particular, the partially lacking availability of appropriate processor performance. The processor performance of processors continues to increase, in particular, as regards so-called General Purpose Computation on Graphics Processing Units (GPGPU), that is to say graphics processors. The available processor performance therefore no longer constitutes a limiting factor, and, for this reason, the robustness and complexity of the simulation used in the course of processor control, in particular, regarding process engineering controls, is in the forefront.

### SUMMARY AND DESCRIPTION

It is therefore an object of the embodiments to provide a method and an apparatus for process control in a physical process that permit a robust simulation of the physical process with acceptable computational outlay.

The scope of the present invention is defined solely by the appended claims and is not affected to any degree by the statements within this summary. The present embodiments may obviate one or more of the drawbacks or limitations in the related art.

According thereto, a method for process control in a physical process running in a prescribed process area includes discretizing of the physical process by particle-based domain decomposition of the process area (PR) into a plurality of partial volumes (V_{T}), in which one particle (P) respectively replaces a multiplicity of objects interacting within the respective partial volume and constitutes a first process parameter (PP1) of the process. The method also includes calculating a second process parameter (PP2), dependent on the first process parameter (PP1), at least for the inner particles (Pᵢ) of the process area (PR) by Local Maximum Entropy (LME) approximation, and calculating the second process parameter (PP2) for the outer particles of the process area (PR) by Moving Least Squares (MLS) approximation on the basis of the second process parameter (PP2) calculated for the inner particles (Pᵢ) of the process area (PR). The method also includes calculating an interaction variable (IG) at least for the inner particles (Pᵢ) of the process area (PR) as a function of the second process parameter (PP2), respectively calculated for the outer particles (Pₐ) of the process area (PR), by LME approximation, and calculating the interaction variables (IG) for the outer particles (Pₐ) of the process area (PR) by MLS approximation on the basis of the interaction variables (IG) calculated for the inner particles (Pᵢ). The method also includes calculating at least one control variable (SG) for controlling the physical process in the process area (PR) as a function of the interaction variables (IG) calculated for the inner and outer particles (Pᵢ, Pₐ). The method also includes setting a target process parameter (ZPP) of the physical process by the calculated control variable (SG).

In one possible embodiment, microscopic objects interact in the process area.

In the case of an alternative embodiment, macroscopic objects interact in the process area.

In a further possible embodiment, mesoscopic objects, that is to say associations of microscopic objects, act in the process area.

In one possible embodiment, the microscopic objects have elementary particles, atoms, molecules and/or microparticles in solid, liquid, or gaseous form.

In one possible embodiment, the macroscopic objects have persons or moving articles, in particular, vehicles.

In one possible embodiment, the mesoscopic objects have associations of microscopic objects.

In one further possible embodiment, the calculation of the interaction variables for the particles is performed iteratively as a function of the second processor parameter.

In one further possible embodiment, the target process parameter of the physical process is formed by a target process parameter of the physical process that is dependent on the first process parameter.

In one further possible embodiment, the interaction variables are formed by forces that prevail between the particles.

In one further possible embodiment, the first process parameter is formed by the particle speed of the particle located within a partial volume of the process area.

In one further possible embodiment, the second process parameter is formed by a stress tensor of the particle located within the partial volume of the process area.

In one further possible embodiment, the control variable controls at least one actuator of the installation in which the process runs.

In one further possible embodiment, the second process parameter of the process is dependent on environmental process parameters of the process that are detected by sensors on or in the process area, and are taken into account in the calculation of the second process parameter as a function of the first process parameter.

In the case of one further possible embodiment, the calculation of the interaction variable for the particles and the calculation of the control variable are performed during the runtime of the process.

In the case of a further possible embodiment, the target parameter of the physical process is controlled by the control variable.

In the case of a further possible embodiment, the target parameter of the physical process is regulated to a desired value.

In the case of a further possible embodiment, the process area of the process is delimited by an article surface of an article to be processed, the article including objects, in particular, atoms or groups of atoms.

The bound may prescribe boundary conditions so that there is no need here to undertake any interpolation, for example, it is provided that V=0 in the case of adhesive boundary conditions (compare DM).

In the case of one possible embodiment, the process area of the process is bounded by an article surface of an article to be processed, the latter being a work piece.

In the case of a further possible embodiment, the process area of the process is bounded by a wall of a flow channel through which objects, (e.g., molecules or groups of molecules), flow.

The bound may prescribe boundary conditions so that there is no need here to undertake any interpolation, for example, it is provided that V=0 in the case of adhesive boundary conditions (compare DM).

In the case of a further possible embodiment, the first parameter of the process is formed or influenced by a particle temperature or a particle pressure of the particle located within a partial volume of the process area.

In certain embodiments, an apparatus for process control includes a discretization unit that decomposes the physical process by particle-based domain decomposition of the process area (PR) into a plurality of partial volumes (V_{T}), in which one particle (P) respectively replaces a multiplicity of objects interacting within the respective partial volume and constitutes a first process parameter (PP1) of the discretized physical process. The apparatus also includes a calculation unit that calculates a second process parameter (PP2), dependent on the first process parameter (PP1), at least for the inner particles (Pᵢ) of the process area (PR) by LME approximation, and calculates the second process parameter (PP2) for the outer particles (Pₐ) of the process area (P_{R}) by MLS approximation on the basis of the second process parameter (PP2) calculated for the inner particles (Pᵢ) of the process area (PR). The calculation device calculates interaction variables (IG) at least for the inner particles (Pᵢ) of the process area (PR) as a function of the second process parameter (PP2) respectively calculated for the outer particles (Pₐ) of the process area (PR), by LME approximation. The calculating device also calculates the interaction variables (IG) for the outer particles (Pₐ) of the process area (PR) by MLS approximation on the basis of the interaction variables (IG) calculated for the inner particles (Pᵢ). At least one control variable (SG) for controlling the physical process in the process area (PR) is determined as a function of the interaction variables (IG) calculated for the inner and outer particles (Pᵢ, Pₐ). The calculation unit sets at least one target process parameter (ZPP) of the physical process by the calculated control variable (SG).

### BRIEF DESCRIPTION OF THE DRAWINGS

FIGS. 1a, 1b depict embodiments of diagrams for comparison of a continuous field that is discretized with the aid of a particle-based domain decomposition.

FIG. 2 depicts one embodiment of a schematic for evaluating a process area discretized by particle-based domain decomposition.

FIG. 3 depicts a further exemplary diagram for illustrating an example for a physical process, discretized by particle-based domain decomposition, with edge particles.

FIG. 4 depicts a block diagram of a possible embodiment of the apparatus for process control.

FIG. 5 depicts a flowchart for illustrating an exemplary embodiment of the method for process control.

FIG. 6 depicts a diagram for illustrating an example of a physical process in the case of which the method and the apparatus for process control may be used.

FIG. 7 depicts an example of a simulation of a physical process from a process control.

### DETAILED DESCRIPTION

Simulation calculations of spatial physical processes may be based on discretizations of the fundamental equations by space grids. Such spatial physical processes are, for example, reactive flows, or flow processes of viscoelastic materials. If large or severe deformations occur in such spatial physical processes, such grid-based discretization methods reach their limits. The same is true concerning the occurrence of free surfaces, or concerning the interaction of a plurality of materials, (e.g., in a fluid-structure interaction). Consequently, in most cases, the grids are repeatedly generated. However, this requires relatively complex algorithms that lead to a high outlay on the implementation.

One alternative to this is offered by the option of resolving complex geometries indirectly on grids. Examples are provided by the volume-of-fluid method and the so-called level-set method. Furthermore, implementation of complex geometries may also be performed by so-called lattice Boltzmann methods. The robustness of such methods of calculation is, however, limited precisely in the case of temporally dynamic geometries. In many cases, such methods of calculation also exhibit only a poor or slight convergence. At the same time, the conventional methods require a similarly high outlay on implementation as grating-based methods with repeated generation of suitable space grids.

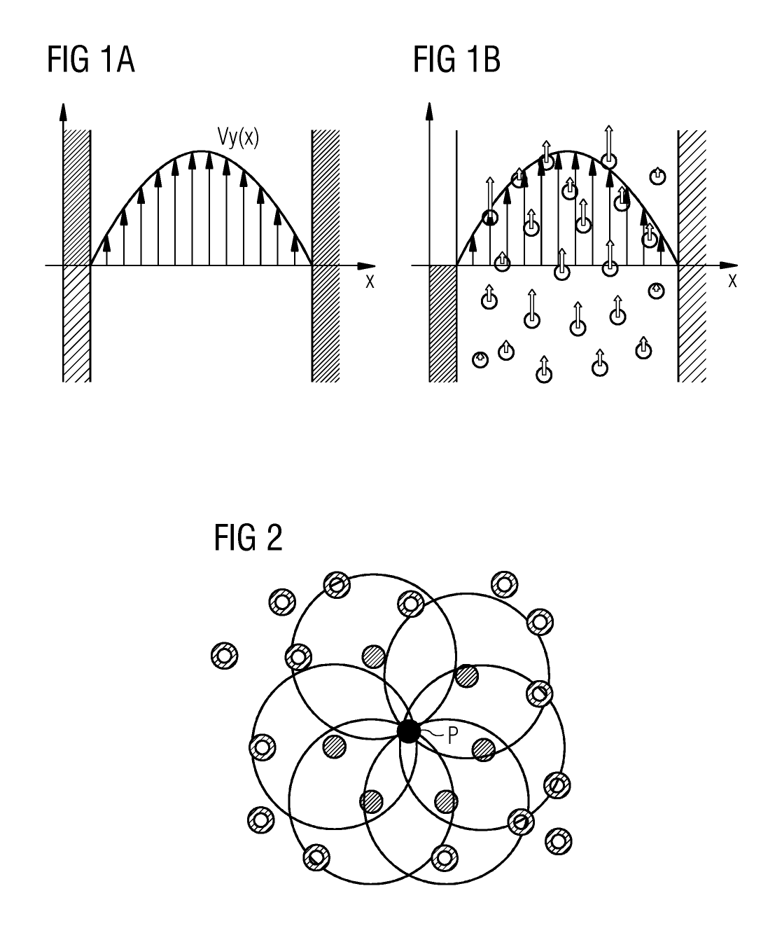

Consequently, particle-based methods (PM) are used for process control in order to discretize the physical process. By contrast with molecular approaches, in the case of such an approach to calculation, it is not the microscopically physical particle interaction that is considered, but a particle-based description. The particles are not physical particles, but virtual particles, which respectively replace a multiplicity of objects interacting within a respective partial volume V_{T}. Here, a continuous variable, (e.g., the speed V inside a flow), is replaced by individual particles or virtual particles P, as depicted in FIG. 1.

The continuous field to be described, (e.g., the flow within a tube as illustrated in FIG. 1a, including the flow profile illustrated), is therefore converted into a superposition of individual local fields and of functions Φⱼ that are respectively assigned to the (virtual) particles P. The virtual particles P may have a limited carrier, that is to say the function Φⱼ(x) is equal to 0 outside a given radius. The functions Φⱼ(x) may be determined by approximation methods on the basis of the properties, for example, by a Moving Least Squares (MLS) approximation as described, (e.g., in G. A. Dilts: “Moving-Least-Squares-Particle Hydrodynamics” Consistency and Stability, Int. J. Numer. Meth. Engng. 44: 1115-1155 (1999)), or by a Local Maximum Entropy (LME) approximation as described, (e.g., in M. Arroyo, M. Ortiz: “Local maximum-entropy approximation schemes: a seamless bridge between finite elements and meshfree methods,” Int. J. Numer. Meth. Engng. 65: 2167-2202 (2006)).

The discretization of the physical process is based on the evaluation with the aid of particle-based methods of individual virtual particles having positions xᵢ, that is to say evaluations of f(xᵢ), in which:

$$f ( x ) = {\sum }_{f = 1}^{N} {f}_{f φ j} ( x ) ,$$

with fᵢ=f(xⱼ).

In this case, it may be sufficient in the evaluation and/or calculation to consider information of the virtual particle P in the vicinity of the points or particle xᵢ, since the functions Φⱼ have a limited carrier. That is to say, the corresponding functions Φⱼ of the description of the particle-based method P are therefore evaluated for each particle at a few points, that is to say the particle positions in the vicinity of the position xᵢ. FIG. 2 illustrates this schematic. Thus, the values Φⱼ(xᵢ) may be determined efficiently by approximation methods, in particular by the Moving Least Squares (MLS) approximation or the Local Maximum Entropy (LME) approximation, such an approximation being carried out on each point x to be evaluated. At the center, FIG. 2 depicts a point to be evaluated or a particle P to be evaluated, and the relevant particles, arranged therearound, with carriers of Φ, that is to say in a zone where Φ≠0. Also to be seen are irrelevant particles at the outer edge. The discretization of the physical process by particle-based domain decomposition of the process area PR into a plurality of partial volumes V_{T} provides that the process is represented by virtual particles P that respectively replace a multiplicity of real objects actually interacting within the respective partial volume V_{T}, and which constitute a first process parameter PP1 of the process.

For example, microscopic objects, in particular, elementary particles, atoms, molecules and/or microparticles in solid, liquid or gaseous form may be located in the process area PR. Alternatively, it is also possible for macroscopic objects, for example, persons or moving articles, possibly vehicles or the like, to be present in the process area PR. Furthermore, it is also possible for there to be present in the process area PR so-called mesoscopic objects that are associations of microscopic objects, for example, associations of microscopic particles, in particular atoms, which results in a virtual superatom. The process area PR of the process may, for example, be bounded by an article surface of an article or workpiece WS to be processed, the workpiece WS including objects, in particular, atoms or groups of atoms. Furthermore, it is possible for the process area PR of the process to be bounded by a wall, (e.g., a flow channel), through which objects, (e.g., molecules or groups of molecules), flow. In the case of the method for process control, the respective physical process is discretized by particle-based domain decomposition of the process area into a plurality of partial volumes V_{T}. In the partial volumes, a particle or virtual particle P respectively replaces a multiplicity of real objects interacting within the respective partial volume, the particle constituting a first process parameter PP1 of the process. For example, the first process parameter PP1 is formed by the particle speed of the particle or virtual particle located within a partial volume of the process area PR. Furthermore, it is possible, for example, for the first process parameter PP1 of the process to be formed by a particle temperature or by a particle pressure of the particle located within the partial volume of the process area, or for the first process parameter PP1 to be influenced thereby.

An exemplary discretization of the compressible Navier-Stokes (NS) equations with a stress tensor that is considered below will further illustrate the process control method:

$$\begin{matrix}\frac{d δ}{d t} = - p ▽ + V \\ p \frac{d V}{d t} = ▽ \cdot σ + F & ( N5 ) \\ σ = - pld + 2 p \dot{e} + λ trace \dot{e} ld with {\dot{e}}_{pd} = \frac{1}{2} {( {δ}_{m} {V}_{p} + {δ}_{p} {V}_{α} )}_{x} , & ( ST )\end{matrix}$$

σ representing the stress tensor, V the speed, and F a force.

The use of a particle-based discretization or a particle-based domain decomposition results after a few acts of calculation in the following discrete representation:

$$\frac{d pi}{d t} = - p i {\sum }_{j} ( {▽φ}_{j} ) \cdot {V}_{f} \\ pi \frac{d {V}_{i}}{d t} = {\sum }_{j} ( {▽φ}_{j} ) \cdot {σ}_{l} + {V}_{i} {f}_{i} \qquad ( DNS )$$

with the stress tensor:

$$σ = - pId + 2 μ d + λ trace \dot{c} ld$$

with (DST)

$${\dot{e}}_{αβ} = \frac{1}{2} {\sum }_{j} ( {V}_{aj} {δ}_{p φ j} + {V}_{β j} {δ}_{α} {φ}_{j} ) .$$

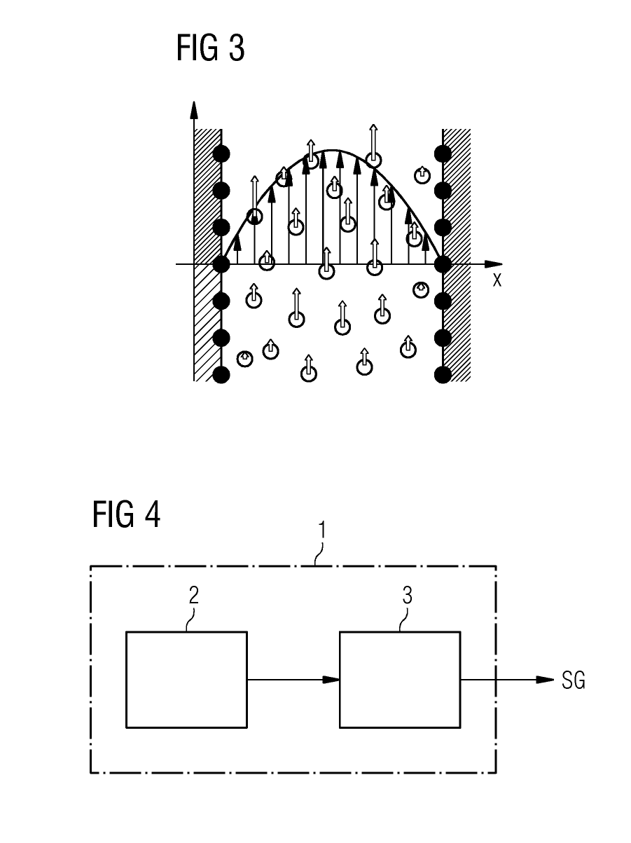

Furthermore, the implementation of the procedure considered above is not trivial for so-called edge particles since, on the one hand, approximation methods do not converge, for example the Local Maximum Entropy (LME) approximation method, or else prescribed boundary values are not exactly represented thereby, as is the case, for example, in the Moving Least Squares (MLS) approximation. The LME approximation method does not converge at edges or edge particles as is illustrated, for example, in FIG. 3. In FIG. 3, edge particles of a process area PR that is bounded by the inner wall of the flow channel are illustrated in black.

It is possible to distinguish different particle types in the particles P. The particle types are inner particles Pᵢ and outer particles Pₐ or edge particles. With the edge particles, it is possible to distinguish, on the one hand, between solid edge particles with essential boundary conditions having prescribed values, (which are also denoted as so-called ghost particles), and free edge particles without prescribed values or only prescribed gradients. The so-called ghost particles are, for example, particles on or at edges with adhesive boundary conditions in a flow. The free edge particles are, for example, particles at a free surface in a flow. By way of example, FIG. 3 depicts free edge particles of a free surface within a flow channel through which, for example, a liquid flows. Many conventional discretization methods have disadvantages, particularly in the case of solid edge particles with essential boundary conditions. In the case of the method for process control, essential boundary conditions for a variable or a process parameter to be simulated may, however, be implemented or considered for example by a permanently prescribed speed at the edge, that is to say the so-called adhesive boundary condition. In this case, use is made of particle-based approximation methods to implement the essential boundary conditions in the case of particle-based methods.

In the case of a physical process, the method for process control makes use of different approximation methods with the aid of an LME approximation and an MLS approximation. In this case, the different approximation methods are coupled within a method for particle-based simulation of a physical process in order to control the process of the latter. Here, there is a coupling of a general approximation method, that is to say a method taking no account of essential boundary conditions, to an approximation method that takes account of essential boundary conditions, for example, in the form of a secondary condition. A MLS (Moving Least Squares) method may be used as an approximation method without taking account of boundary conditions, and a LME (Local Maximum Entropy) may also be used as an approximation method, which takes account of essential boundary conditions. The method calculates, at least for the inner particles Pᵢ of the process area PR, a second process parameter dependent on the first process parameter PP1 by LME approximation. The method also calculates a second process parameter PP2 for the outer particles Pₐ of the process area by MLS approximation on the basis of the second process parameter PP2 calculated for the inner particles Pᵢ of the process area PR. For example, the first process parameter PP1 is formed by the particle speed V of the particle located within a partial volume V_{T} of the process area PR. Furthermore, the second process parameter PP2 in this example may be formed by a stress tensor T of the particle P located within the partial volume V_{T} of the process space PR. The stress tensor σ is proportional to the divergence of the speed V. The speed V is a continuous physical variable. Further examples of such physical variables are pressure Pᵢ temperature T, deformations, or other mechanical continuous variables. Furthermore, the continuous physical variables may also be electrical variables such as voltage U or the like. The respective physical variable, (e.g., the Speed V), may be governed by a natural physical law, including the second space derivative of the respective physical variable being considered itself. This is the case, for example, with the temperature. Furthermore, this also applies, for example, to the speed V (V.=D×C(T)D×V+Fₑₓₜₑᵣₙ), C representing a temperature-dependent constant and Fₑₓₜₑᵣₙ representing an external force. Furthermore, the stress tensor σ is given by C(T)D×V. The method for process control may be suitable for a physical process that has at least one such continuous physical variable.

After calculation of a second process parameter PP2, dependent on the first process parameter PP1, for the inner particles Pᵢ of the process area PR by LME approximation, and calculation of the second process parameter PP2 from the outer particles Pₐ of the process area PR by MLS approximation, the calculation of an interaction variable IG is performed in a further act. This interaction variable IG may be, for example, physical forces F that prevail between the particles P. In this case, an interaction variable IG is calculated, at least for the inner particles Pᵢ of the process area PR, as a function of the second process parameter PP2 respectively calculated for the outer particles Pₐ of the process area PR, by LME approximation. The interaction variables IG are calculated for the outer particles Pₐ of the process area PR by MLS approximation on the basis of the interaction variables IG calculated for the inner particles, to the extent this is not determined by boundary conditions or sensor values. In the methods, the interaction variables IG, (e.g., forces), are used to calculate new particle positions of particles, the particles having a speed. Thereupon, a new first process parameter PP1 is calculated interactively on the basis of the interaction variables. Subsequently, at least one control variable SG for controlling the physical process in the process area PR is determined as a function of the interaction variables IG, (e.g., forces F), calculated for the inner and outer particles. Subsequently, a target process parameter ZPP of the physical process is set by the calculated control variable SG. For example, the control variable SG may control at least one actuator of the technical installation in which the respective process runs.

The second process parameter PP2 of the process may depend on environmental process parameters UPP. The environmental process parameters UPP are detected by sensors. In this case, the environmental process parameters UPP may be detected by sensors at or within the process area PR. The environmental process parameters UPP may be taken into account during the calculation of the second process parameter PP2 as a function of the first process parameter PP1. In the case of one possible embodiment of the method, the target parameter ZPP of the physical process is controlled by the control variable SG or regulated to a desired value. The calculation of the interaction variables IG, for example the forces F, for the particles P, and the calculation of the control variable SG may be performed during the runtime of the process P within the installation. The simulation of a continuum-mechanical process, (e.g., within the mechanism or flow mechanism), may be performed, for example, by so-called compressible Navier-Stokes equations. In this case, it is possible, for example, to determine speed values and their derivatives at inner material points and also at free edge points for calculating the stress tensor with the aid of the equation (DST), in each case with a Local Maximum Entropy approximation (LME). Both inner and outer points and/or particles are used to calculate the approximation. This is possible because the essential edge particles are also allotted a decided value by the boundary conditions. For example, the speed is V=0 in the case of adhesive boundary conditions. By contrast therewith, derivatives of the stress tensors σ, for which the equation (DNS) is required, are not defined from the essential edge particles.

For inner particles directly at the edges, corresponding gradients therefore may not be determined straightaway by the LME method, since the LME method does not converge. However, since the gradients are required for the determination of the forces and/or the interaction variables IG at the inner particles Pᵢ (as follows from the equation (DNS)), and the interaction variables IG are required, in turn, for the integration of a time step method, the LME approximation and the MLS approximation are used in combination or in common in the method for process control. Accordingly, a second process parameter PP2 dependent on the first process parameter PP1 is calculated at least for the inner particles Pᵢ of the process area PR by LME approximation. Furthermore, the second process parameter PP2 for the outer particles Pₐ of the process area is calculated by MLS approximation on the basis of the second process parameter PP2 calculated for the inner particles Pᵢ of the process area PR. By way of example, stress tensors σ are determined for the inner particles Pᵢ from the speed gradients by LME approximation from all the particles. Furthermore, stress tensor values are extrapolated of the outer particles Pₐ from the internally determined stress tensors by MLS approximation. Moreover, forces F are determined as interaction variables IG from stress tensor derivatives for the inner particles Pᵢ by LME approximation.

In the case of one possible embodiment of the method, a distinction is made only between essential edge points and freely moving particles, which is to say between inner particles and free n₁ edge particles. In this case, particles at free surfaces are treated like inner particles Pᵢ. However, if an LME approximation fails at the free edge particles, it is possible in this case, in one advantageous implementation, too have recourse to MLS approximation of zeroth order, that is to say the so-called Shepar functions.

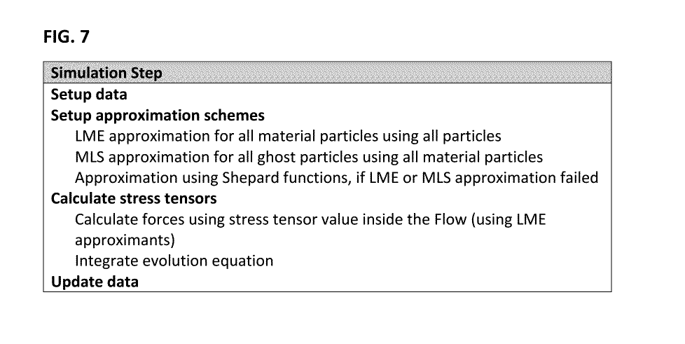

An example of the simulation of a physical process from a process control is depicted in FIG. 7.

By comparison with conventional particle-based methods (e.g., Smooth Particle Hydrodynamics), particle-based methods that are based on interpolation methods and/or approximation methods offer a distinctly higher accuracy. Conventional methods do not permit exact interpolation of a linear function (consistency of first order). By combining a particle-based method PM with appropriate interpolation methods, the consistency of first order is provided.

Possible interpolation methods capable of use include the Moving Least Squares (MLS) interpolation and the Local Maximum Entropy (LMS) interpolation. On the one hand, the advantage of the MLS interpolation or approximation resides in a lesser computational outlay and permits the solution of a 4×4 matrix in 3 dimensions with consistency of the first order by comparison with an LME interpolation. On the other hand, there is the advantage of the LME interpolation as against an MLS interpolation or approximation, which resides in the exact reproduction of boundary values. If an evaluation point of the interpolation approaches an edge particle, so too does the interpolated value approach the function value of the edge particle. If the values at the edge particles are prescribed, for example, by boundary conditions/sensor values, this offers a substantial advantage. In the case of adhesive boundary conditions (e.g., flow rate at the edge=edge speed), this constitutes an important property that determines the quality of the results of calculation of simulations. In order to implement the property within an MLS interpolation as well, there is conventionally the need for a substantial computational outlay that conventionally restricts the robustness of the simulation. Consequently, in the case of the method for process control, the LME approximation and the MLS approximation are coupled or combined in order to exploit the advantages of the respective interpolation or approximation method.

An LME interpolation or LME approximation may only be evaluated in a region or process area with exclusion of the edge. This is a limitation inherent to the approximation method. The LME interpolation does not offer the possibility of extrapolation of values from the particle zone. If this is not possible, for example, in the case of edge particles, and if the corresponding values at the particles are not prescribed by essential boundary conditions or sensor values, it is possible to have recourse to an LMS interpolation.

The method for process control is suitable for implementation with particle-based methods PM, an implementation of the boundary values, that is to say values at the edge particles, being achieved by a skillful combination of LME approximation and MLS approximation. The method for process control is distinguished by a combination of different approximation methods for a particle-based method. Very different boundary conditions may be efficiently realized by the combination of two approximation methods. The method for process control is distinguished, in particular, by the following advantages. The method permits the implementation of any desired boundary conditions in particle-based methods, in particular, simulation methods. Furthermore, the method permits a massive parallelization of calculation algorithms, for example, on graphics cards or the like. Furthermore, in the case of the method the modeling of very different physical phenomena and/or parameters is relatively simple, since the modeling may always be interpreted as a simple multibody system (e.g., Newton's point mechanics). The method for process control is, moreover, particularly robust and permits an exact control and/or regulation of target process parameters ZPP. By contrast with conventional grid-based methods, it is possible in this case for simple heuristics to substantially increase the stability of the method of calculation and/or the simulation. Furthermore, the outlay on implementation of the method for process control is relatively slight, the result being to provide excellent portability to other computational architectures.

FIG. 4 depicts a block diagram of one possible exemplary embodiment of a process control apparatus 1. The process control apparatus 1 illustrated in FIG. 4 serves to control a physical process by a control variable SG that is output at an output of the apparatus. A target process parameter ZPP of the physical process may be set with the aid of the control variable SG. The calculation of the control variable SG may be performed during the runtime of the respective process on a technical installation. For example, the control variable SG output by the apparatus 1 may set or operate an actuator of the installation in which the physical process runs. The actuator is, for example, a valve or the like. Furthermore, the process control apparatus 1, as it is illustrated in FIG. 1, is coupled to the process by sensors in one possible embodiment. For example, the sensors may be used to detect the environmental process parameters UPP of the process. The physical process runs in a prescribed process area PR. The process area PR may, for example, be bounded by a wall of a flow channel, through which objects, (e.g., molecules or groups of molecules), flow. Furthermore, the process area PR may, for example, be an area that is bounded by an article surface of an article to be processed, in particular, a workpiece WS. The workpiece WS includes, for its part, objects, in particular, atoms or groups of atoms.

As illustrated in FIG. 4, the process control apparatus 1 has a discretization device 2 and a calculation device 3. The discretization device 2 and the calculation device 3 may respectively be implemented by powerful processors. Alternatively, it is also possible for both the discretization device 2 and the calculation device 3 to be implemented on a high performance processor. The discretization device 2 decomposes and discretizes the respective physical process by particle-based domain decomposition of the process area PR into a plurality of partial volumes V_{T} in which there is respectively located a particle or a virtual particle P that replaces a multiplicity of real objects interacting within the respective partial volume V_{T}, and constitutes a first process parameter PP1 of the process. For example, the process parameter PP1 is formed by the particle speed V of the virtual particle located within a partial volume V_{T} of the process area PR.

The calculation device 3 carries out a calculation of a second process parameter PP2, dependent on the first process parameter PP1, at least for all inner particles of the process area by LME approximation. If the first process parameter PP1 is, for example, the particle speed V, the calculated second process parameter PP2 is, for example, a stress tensor σ of the particle P located within the partial volume of the process area PR. Furthermore, the calculation unit 3 carries out a calculation of the second process parameter PP2 for the outer particles Pₐ of the process area by MLS approximation on the basis of the second process parameter PP2 calculated for the inner particles Pᵢ of the process area PR, for example, the stress tensor G. Thereupon, the calculation device 3 calculates an interaction variable IG at least for the inner particles Pᵢ of the process area PR as a function of the second process parameter PP2 respectively calculated for the outer particles Pₐ of the process area PR. The interaction variable IG is, for example, physical forces F. Furthermore, the interaction variables IG for the outer particles Pₐ of the process area PR are calculated by MLS approximation on the basis of the interaction variables IG calculated for the inner particles Pᵢ, if not prescribed by boundary condition or sensor values. The calculation of the interaction variables IG, for example, the forces F, for the particles P may be likewise performed during the runtime of the physical process P within the installation. Moreover, the calculation device 3 calculates at least one control variable SG for controlling the physical process in the process area PR as a function of the interaction variables IG, for example, the forces, calculated for the inner and outer particles. The calculation of the control variable SG may also be performed during the runtime of the process in the installation. Subsequently, the process control apparatus 1 outputs the calculated control variable SG via an interface for setting a target process parameter ZPP of the physical process. The control variable SG may, for example, set an actuator within the process installation. The setting may also be performed during the runtime of the process. In the case of one possible variant embodiment, the setting of the target process parameter is performed in real time in response to sensed changes in environmental process parameters UPP of the process. In this case, the second process parameter PP2 of the process, for example, the stress tensor σ, may depend on environmental process parameters UPP of the process. The latter are detected by sensors that are fitted in or on the process area, and there are also taken into account in the calculation of the second process parameter PP2, (e.g., the stress tensor σ), as a function of the first process parameter PP1, (e.g., the speed V).

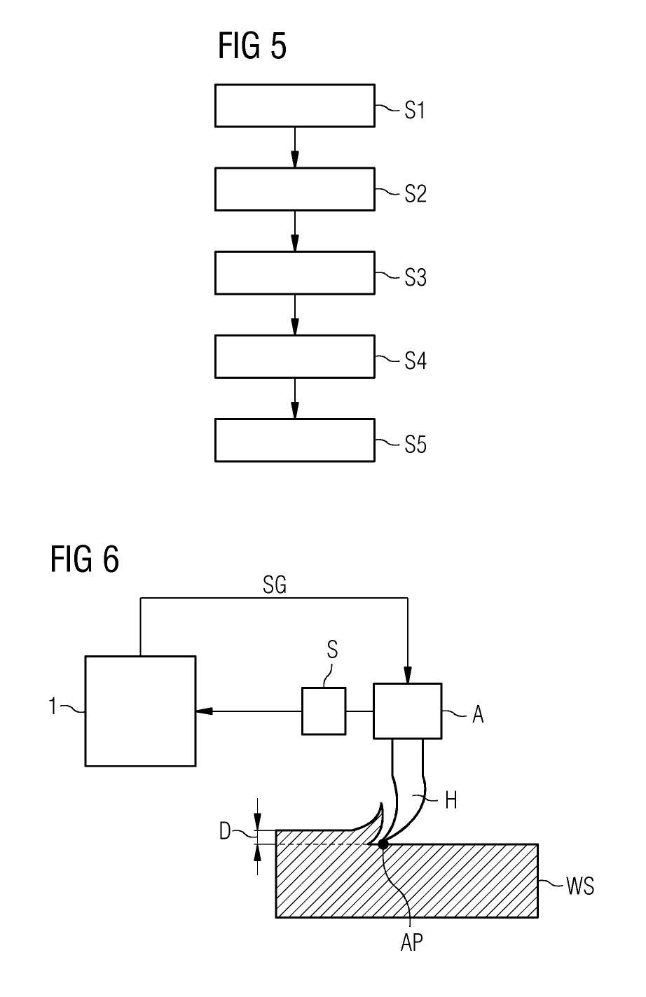

FIG. 5 depicts a flowchart for the purpose of illustrating an exemplary embodiment of the method for process control in the case of a physical process within an installation.

In act S1, a discretization of the physical process is performed by particle-based domain decomposition of the process area PR into a plurality of partial volumes V_{T} in which a particle or virtual particle respectively replaces a multiplicity of objects interacting within the respective partial volume V_{T}, and constitutes a first process parameter PP1 of the process.

In act S2, there are performed a calculation of a second process parameter PP2 dependent on the first process parameter PP1, at least for the inner particles Pᵢ of the process area PR by LME approximation, and a calculation of the second process parameter PP2 for the outer particles Pₐ of the process area by MLS approximation on the basis of the second process parameter PP2 calculated for the inner particles Pᵢ of the process area PR.

In act S3, at least one interaction variable IG, for example a force F, is calculated, at least for the inner particles Pᵢ of the process area PR, as a function of the second process parameter PP2 respectively calculated for the outer particles Pₐ of the process area PR, by LME approximation. Furthermore, the interaction variables IG for the outer particles Pₐ of the process area PR are calculated by MLS approximation on the basis of the interaction variables IG calculated for the inner particles Pᵢ.

In act S4, at least one control variable SG for controlling the physical process in the process area PR is calculated as a function of the interaction variables IG calculated for the inner and outer particles Pₐ.

In act S5, a target process parameter ZPP of the physical process is set by the calculated control variable SG.

FIG. 6 depicts a diagram illustrating a simple example of a process that is controlled with the aid of the method for process control and by the apparatus 1 for process controlled.

As may be seen from FIG. 6, a workpiece WS, for example, a workpiece made from metal, is machined with the aid of a planing tool H in the illustrated process. In this case, the planing tool H removes a layer of thickness D at the upper edge of the workpiece WS. By way of example, the workpiece WS has a temperature T. The plane or tool H is applied at an application point AP. The process area PR of the process is bounded by the article surface of the article to be machined, for example by the surface of the workpiece WS. The workpiece WS includes objects, specifically, atoms and/or of molecules and/or groups of atoms or groups of molecules. By way of example, the workpiece WS includes metal atoms that constitute the interacting objects. The planing tool H is connected to an actuator A that is controlled by a process control apparatus 1. For this purpose, the process control apparatus 1 outputs a control signal or a control variable SG to the actuator A in order to adjust the position or orientation of the planing tool H. Furthermore, an external force Fₑₓₜ may be set at the application point AP. An applied force F_{AP} is thereby set. The applied force F_{AP} depends on the divergence of the stress tensor σ of the workpiece WS, and of the external force Fₑₓₜ:

F_{AP}=div·σ=AP+Fₑₓₜ

Applying the planing tool H to the upper surface of the workpiece WS produces in the workpiece WS a slight mechanical deformation that is detrimental to the accurate removal of the upper layer. In the case of the process illustrated in FIG. 6, the intention is for the layer on the workpiece WS that is removed, specifically for the thickness d of the layer removed, to be as constant as possible. In the case of the exemplary process illustrated, the layer thickness d therefore constitutes a target process parameter ZPP of the physical process. The external force EFₑₓₜ exerted by the planing tool H may be detected. The divergence of the stress tensor σ of the workpiece WS is calculated with the aid of the process control method for determining the deformation of the workpiece WS. The process area PR, which is bounded by the surface of the workpiece WS, is firstly discretized by the process control apparatus 1 and decomposed into a plurality of partial volumes in which a virtual particle P respectively replaces a multiplicity of interacting objects, for example, metal atoms, within the respective partial volume, the particle or virtual particle P constituting a first process parameter PP1 of the process. The first process parameter is, for example, a speed V at the respective material point or particle. Subsequently, the process control apparatus 1 calculates, at least for the inner particles Pᵢ of the process area PR a second process parameter PP2 dependent on the first process parameter, that is to say the speed, by LME approximation. For example, the stress tensor σ is calculated at all the points, except the edge points, from the divergence of the speed V. The stress tensor σ may depend on an environmental process parameter UPP, for example, the temperature T. Furthermore, the second process parameter PP2, (e.g., the stress tensor σ), is calculated for the outer particles Pₐ of the process area PR, that is to say for the surface particles of the workpiece WS, by MLS approximation on the basis of the second process parameter PP2 calculated for the inner particles Pᵢ of the process area PR, that is to say for the stress tensor σ calculated therefor. Thereupon, as interaction variables IG, the forces F are thereupon calculated, at least for the inner particles Pᵢ of the process area PR, as a function of the second process parameter PP2 respectively calculated for the outer particles Pₐ of the process area PR. Subsequently, the forces F are calculated here for the outer particles Pₐ of the process area PR by MLS approximation on the basis of the forces F calculated for the inner particles Pᵢ, to the extent they are not prescribed or determined by sensor. Subsequently, a control variable SG for operating the actuator is calculated as a function of the forces F calculated for the inner and outer particles and, in particular, a force F at the application point AP to which the planing tool H is applied to the surface of the workpiece WS. The control variable SG subsequently sets the actuator A for the planing tool as a function of the calculated control variable SG.

The method permits a robust online control of complex physical processes, in particular including complex flow processes or the like. The method for process control is not limited to the processes as specified in the exemplary embodiments, but is suitable for any physical process in a bounded process area PR in which objects interact. The method offers a higher accuracy through control configured to deformations, this leading, in turn, to a lower wear of the tool or a lower energy consumption.

By way of example, the method illustrated in FIG. 5 may be executed by a process control program that runs on a high performance processor. The control program is executed during the runtime or operating time of the processor. In one possible design variant, the process control is performed in real time by such a process control program. The embodiments further provide a process control apparatus that executes such a control program for process control. Moreover, the embodiments provide a process installation of at least one process control 1, as depicted for example in FIG. 4. In the case of one possible embodiment, a target process parameter ZPP of the physical process is regulated by the control variable SG. Furthermore, it is possible one design variant for the target process parameter ZPP, for example, the layer thickness D illustrated in FIG. 6, to be regulated to a desired value.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A method for process control in a physical process running in a process area, the method comprising:
(a) discretizing of the physical process by particle-based domain decomposition of the process area into a plurality of partial volumes, wherein one particle respectively replaces a multiplicity of objects interacting within the respective partial volume and defines a first process parameter;
(b) calculating a second process parameter, dependent on the first process parameter, for inner particles of the process area by Local Maximum Entropy (LME) approximation;
(c) calculating a second process parameter for outer particles of the process area by Moving Least Squares (MLS) approximation on the basis of the second process parameter for the inner particles;
(d) calculating an interaction variables for the inner particles of the process area as a function of the second process parameter respectively calculated for the outer particles of the process area, by LME approximation;
(e) calculating interaction variables for the outer particles of the process area (PR) by MLS approximation on the basis of the interaction variables for the inner particles;
(f) calculating at least one control variable for controlling the physical process in the process area as a function of the interaction variables calculated for the inner particles and the outer particles; and
(g) setting a target process parameter by the calculated control variable.

2. The method as claimed in claim 1, wherein microscopic objects, macroscopic objects, and mesoscopic objects that interact with one another are contained in the process area.

3. The method as claimed in claim 2, wherein the microscopic objects comprise one or more: elementary particles, atoms, molecules, or microparticles in solid, liquid, or gaseous form,
wherein the macroscopic objects comprise persons and/or moving articles, and
wherein the mesoscopic objects comprise associations of microscopic objects.

4. The method as claimed in claim 1, wherein the calculation of the interaction variables for the particles is performed iteratively as a function of the second process parameter.

5. The method as claimed in claim 1, wherein the target process parameter is dependent on the first process parameter.

6. The method as claimed in claim 1, wherein the interaction variables are formed by forces that prevail between the particles.

7. The method as claimed in claim 1, wherein the first process parameter is formed by the particle speed of the particle located within the partial volume of the process area.

8. The method as claimed in claim 1, wherein the second process parameter is formed by a stress tensor of the particle located within the partial volume of the process area.

9. The method as claimed in claim 1, wherein the control variable controls at least one actuator.

10. The method as claimed in claim 1, wherein the second process parameter is dependent on environmental process parameters which are detected by sensors on or in the process area and taken into account in the calculation of the second process parameter as a function of the first process parameter.

11. The method as claimed in claim 1, wherein the calculation of the interaction variable for the particles and the calculation of the control variable is are performed during the runtime.

12. The method as claimed in claim 1, wherein the target parameter is controlled by the control variable or regulated to a desired value.

13. The method as claimed in claim 1, wherein the process area is delimited by an article surface of an article to be processed.

14. The method as claimed in claim 1, wherein the process area is bounded by a wall of a flow channel through which molecules flow.

15. The method as claimed in claim 1, wherein the first parameter is formed by a particle temperature or a particle pressure of the particle located within a partial volume of the process area.

16. A process control apparatus for process control in a physical process running in a process area, the apparatus comprising:
a discretization device configured to discretize by a particle-based domain decomposition of the process area into a plurality of partial volumes, wherein one particle respectively replaces a multiplicity of objects interacting within the respective partial volume and defines a first process parameter;
a calculation device configured to calculate:
(1) a second process parameter, dependent on the first process parameter, for inner particles of the process area by Local Maximum Entropy (LME) approximation;
(2) calculating a second process parameter for the outer particles of the process area by Moving Least Squares (MLS) approximation on the basis of the second process parameter calculated for the inner particles;
(3) interaction variables for the inner particles of the process area as a function of the second process parameter, respectively calculated for the outer particles of the process area, by LME approximation;
(4) calculating interaction variables for the outer particles of the process area by MLS approximation on the basis of the interaction variables calculated for the inner particles; and
(5) at least one control variable for controlling the physical process in the process area as a function of the interaction variables calculated for the inner particles and the outer particles,
wherein a target process parameter is configured to be set by the calculated control variable.

17. The process control apparatus as claimed in claim 16, wherein microscopic objects, macroscopic objects, and mesoscopic objects that interact with one another are contained in the process area.

18. The process control apparatus as claimed in claim 17, wherein the microscopic objects comprise one or more: elementary particles, atoms, molecules, or microparticles in solid, liquid, or gaseous form,
wherein the macroscopic objects comprise persons and/or moving articles, and
wherein the mesoscopic objects comprise associations of microscopic objects.

19. The process control apparatus as claimed in claim 16, wherein the calculation of the interaction variables for the particles is performed iteratively as a function of the second process parameter.

20. The process control apparatus as claimed in claim 16, wherein the target process parameter is dependent on the first process parameter.
